(19) United States
(12) Patent Application Publication
(10) Pub. No.: US 2022/0322652 A1
(43) Pub. Date: Oct. 13, 2022

(54) CABLE CLAMP FOR TRAPPING

(71) Applicant: Casey W. Shope, Gladstone, MI (US)

(72) Inventor: Casey W. Shope, Gladstone, MI (US)

(21) Appl. No.: 17/719,312

(22) Filed: Apr. 12, 2022

Related U.S. Application Data
(60) Provisional application No. 63/173,624, filed on Apr. 12, 2021.

(51) Int. Cl. A01M 23/08

(52) U.S. Cl. CPC A01M 23/08; A01M 2200/00

(57) ABSTRACT

A cable clamp and method of use for trapping animals, which can be clamped onto a drowning cable or wire at an appropriate position to provide the length of cable or wire with the amount of tension or slack necessary in the cable when it is anchored in the water and on shore, by using a cable clamp, longer drowning cables may always be used. The cable clamp includes a connector for connecting to a drowning cable anchor and a plate having a first aperture receiving a clamping bolt for clamping to a drowning cable. The plate also has a locating tab projecting from said plate to serve a locator guide to help a trapper position a drowning cable in tension under the clamping bolt. A channel tab extends upwardly from the plate at a distance from one side of the clamping bolt sufficient to form a channel through which a drowning cable can pass after passing by and contacting the locating tab.

The cable clamp can alternatively be used as a slide lock on a drowning cable or drowning rod in that the plate includes a is a trap connector aperture and a slide lock tab projecting upwardly from the plate at an end spaced from the trap connector aperture and including a third aperture through which a drowning cable or drowning rod can freely pass until an animal is trapped and the plate is canted at an angle to a drowning rod or drowning cable.

### RELATED APPLICATIONS/PRIORITY BENEFIT CLAIM

This application claims priority to Provisional Application Ser. No. 63/173,624, filed Apr. 12, 2021, the content of which is incorporated herein by reference.

### FIELD

The instant invention relates to the trapping of fur bearing animals, such as beaver and otter, but could be used for other fur bearing aminals.

### BACKGROUND

Fur bearing animals are typically trapped by using a combination of an immobilizing trap coupled with a drowning cable or wire. The trap is set with associated bait and connected by an attached or integral short chain via a slide lock to a drowning cable or drowning wire.

When a drowning cable is used, it is anchored at one end to the bottom of a nearby stream by a stake or anchor, and at the other end to a ground stake or some other shore based anchor which will keep the shore end of the cable in place. The trap is set freely on the ground in a convenient location.

When an animal gets caught in the trap, it instinctively scampers to the water and swims downwardly for protection. The slide lock is configured to slide down freely on the cable so that the animal can freely swim downwardly. However, it is also configured to bind on the cable when the animal tries to swim back upwardly when it needs air.

All drowning cables come in different lengths with a loop on each end to facilitate anchoring at the bottom of the stream at one end, and on shore at the other end. The loops facilitate anchoring by looping over a stump or a weight. Different length cables are provided because different streams have different depths, varying depths, and different distances between the stream and a practical place on land to set the trap. For shorter distances, a shorter drowning cable will be used because the trapper doesn't want too much slack between the looped ends of the drowning cable when they are anchored on shore and in the water. On the other hand, longer length drowning cables will be required for example if the stream is too deep or if the deep part of the stream is too far from the shore to allow use of a shorter drowning cable. If a trapper has a shorter drowning cable, they must set in the water that gets deep fast, so the animal is dispatched quickly. If a trapper has longer drowning cables, they must be able to get the drowning cable end out far enough so the cable can be anchored to land securely.

Drowning wire come on a coil of wire. The trapper removes the appropriate length of wire from the coil, and wraps it around some anchoring root or other object or anchor in the water and twists the ware to keep it from coming loose from the anchor. The trapper then does the same at the shore end of the wire. Wire is often used with smaller animals trapped in lighter traps. The function and operation of the slide lock is however the same as when the heavier cables are used.

The term “drowning cable” as used herein is intended to encompass either a drowning cable or a drowning wire, though sometimes the phrase “drowning cable or drowning wire” are used to encompass the alternatives, and sometimes the term “drowning cable/wire” is used to encompass the alternatives.

Sometimes trappers mount the slide lock on a length of steel rod, such as rebar. They usually bend it into somewhat of a curved shape. They embed one end of the rebar into the stream bed, and the other end is accessible on shore. The chain of the immobilizing trap is conned by the slide lock directly to the rebar by sliding the slide lock over the exposed end of the rebar. When the trapped animal heads for the stream, the slide lock slides down on the rebar, but is canted against sliding up thus preventing the animal to come up for air.

### BRIEF SUMMARY OF THE INVENTION

The present invention is a cable clamp which can be clamped onto a cable or wire at an appropriate position to provide the length of cable or wire with the amount of tension or slack necessary in the cable when it is anchored in the water and on shore, by using a cable clamp, longer drowning cables may always be used. Once the drowning cable is anchored in deep water the trap is connected by an attached or integral short connector via a slide lock to a drowning cable or drowning wire which is slid over the end of the drowning cable and positioned in the desired position for trapping the animal. The drowning cable is drawn through the slide lock until the desired tension on the drowning cable is achieved. A cable clamp is clamped to the drowning cable at a point which will ensure that that the desired tension is maintained when a ground stake is embedded at that location.

One either connects the cable clamp to a stake first and then embeds the stake in the ground, or once the ground stake is placed in the ground and the drowning cable/wire is connected to the cable clamp, the drowning cable is connected to the embedded stake. Some embodiments are more conducive to one or the other of these method variations.

Although the use of a drowning cable with an anchoring loop at one end and a free end at the other is preferred, the invention can also be practiced using drowning wire. The use of a cable with one looped end is preferred because it is easier to secure at both the looped end and the cable clamped end than where a coil of wire is carried and has to be wrapped and twisted at least at one end to secure it.

In one embodiment, the cable clamp can be optionally used not only as a cable clamp, but also simply as a slide lock on a steel bar.

These and other features and advantages will be more fully understood and appreciated by reference to the written description of the preferred embodiments and the appended claims.

### BRIEF DESCRIPTION OF THE DRAWINGS

FIG. 1 shows a top view of style A of the cable clamp.

FIG. 2 shows a side view of style A of the body.

FIG. 3 shows a top view of style A of the cable clamp body.

FIG. 4 shows a top view of style B of the cable clamp body in one application, but a bottom view in another.

FIG. 5 shows a side view of the style B cable clamp body.

FIG. 6 shows a top view of the style B cable clamp body being used as a cable clamp.

FIG. 7 shows a side view of the style B cable clamp body mounted on a drowning rod (rebar) for use as a slide lock.

FIG. 8 shows the same view as FIG. 7, but with the clamp body-slide lock canted upwardly in its lock down position.

FIG. 9 shows an angled back/bottom side of a style C type of cable/wire clamp.

FIG. 10 shows another view of the style C type of cable/wire clamp.

FIG. 11 shows another view of the style C type of cable/wire clamp.

FIG. 13 shows another view of the style C type of cable/wire clamp,

FIG. 12 shows another view of the style C type of cable/wire clamp.

FIG. 14 shows a side view of a style D cable clamp body.

FIG. 15 shows the bottom view of the style D drowning cable/drowning rod clamp.

FIG. 16 shows the body of the style D drowning cable/drowning rod clamp connected to a ground stake.

FIG. 17 shows the way the style D drowning cable/drowning rod clamp can be used.

FIG. 18 shows the style D drawing cable/drowning rod body being used to secure a drowning rod in place.

FIG. 19 is also a way to use the style D drowning cable/rebar clamp body connected to rebar lock.

### DETAILED DESCRIPTION OF THE PREFERRED EMBODIMENTS

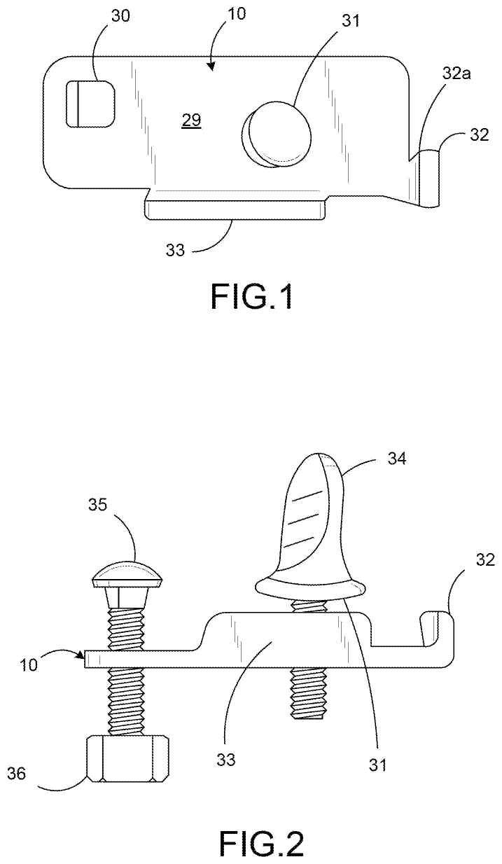

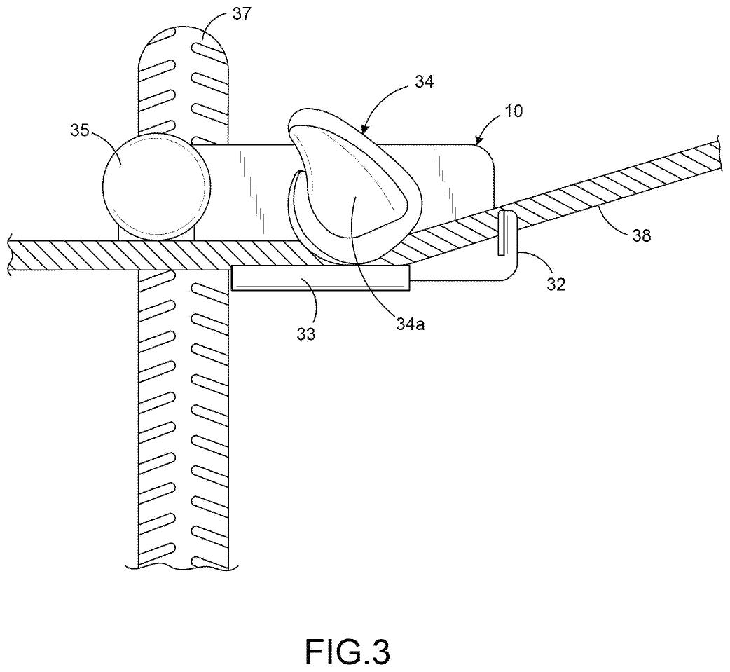

There are four variations of preferred embodiments of the invention identified herein as body style A (10), body style B (11), body style C (12), and body style D (13). The body 10 of the Style A cable clamp has a flat plate 29 with a square aperture 30 through which a threaded bolt 35 passes. It threads into a threaded nut 36 such that bolt 35 and nut 36 can be tightened around ground stake 37, or through a hole drilled through ground stake 37 to connect the body 10 of style A clamp to a ground stake 37. A threaded circular aperture 31 in plate 29 receives a threaded thumb screw 34. A 90-degree bent tab 33 on one side of flat plate 29 adjacent thumb screw 34 serves to channel a drowning cable 38 between tab 33 and thumb screw 34, and under the “thumb” top portion 34a of the bolt, which projects radially outwardly from the shank of bolt 34. A 90-degree bent tab 32 at the end of plate 29, opposite stake connecting bolt 35, is slanted on the inside edge to form an undercut notch 32a with plate 29, which also helps capture drowning cable 38 and guide it into the channel between tab 33 and thumb screw 34. At this point, the drowning cable 38 has been anchored in the water and the trapper has pulled it through this channel until he feels the desired degree of tension on the drowning cable. The trapper then threads thumb screw 34 down over drowning cable 38, clamping the style A clamp drowning cable 38 to hold the desired tension (FIGS. 1, 2 and 3).

Body style B cable clamp has a cable clamp body 11 which is similar to body 10 of style A cable clamp, with a couple of additions. As with the Style A cable clamp body 10, style B cable clamp body 11 has a flat plate 29 with a square aperture 30, a circular aperture 31, a 90-degree bent tab 33, and a 90-degree bent tab 32 forming a V angle 32a with flat plate 29. Using these features, cable clamp 11 can be used in the same ways cable clamp 10 is used.

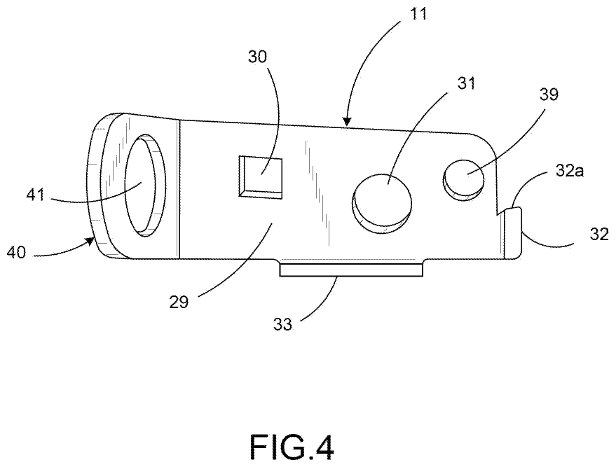

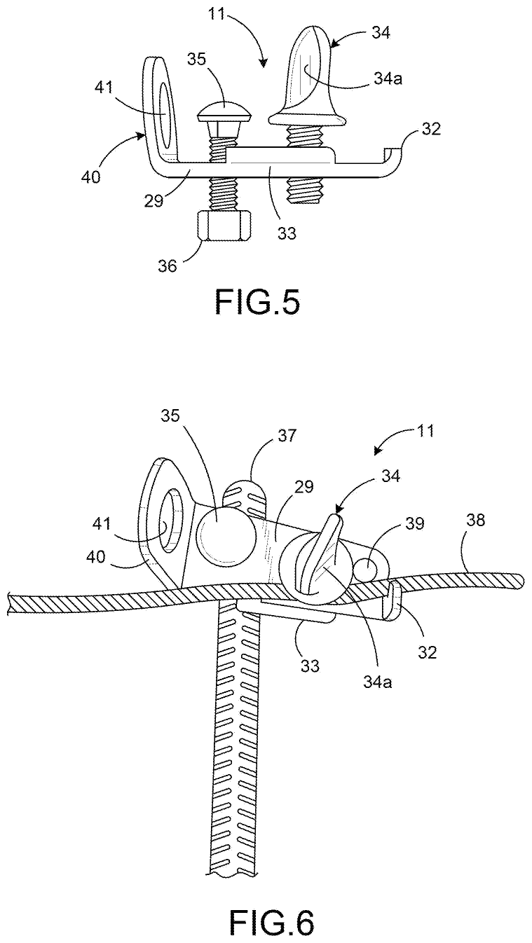

However, cable clamp body 11 has additional features which allow it to be used as a slide lock on a drowning cable or on a drowning rod, rather than as a means for clamping a drowning cable to an anchor. An additional bent tab 40 is located at the left end of clamp body 11 (as viewed in FIGS. 4, 5 & 6) which includes a circular aperture 41. Tab 40 is bent upwardly at about 90-degrees, but preferably about 120-degrees, with respect to clamp body 11. An additional hole 39 is provided near the end of body 11 opposite tab 40, providing a way to attach the immobilizing trap directly to body 11. The tab 40, the additional circular aperture 41, and the trap attaching hole 39 are added to style B cable clamp so that the Style B cable clamp may alternatively be used for a trap drowning slide lock on a drowning cable or a drowning rod such as a length of rebar, by hooking the trap on at hole 39 and passing the end of a drowning cable 38 or drowning rod 37 through aperture 41 in tab 40.

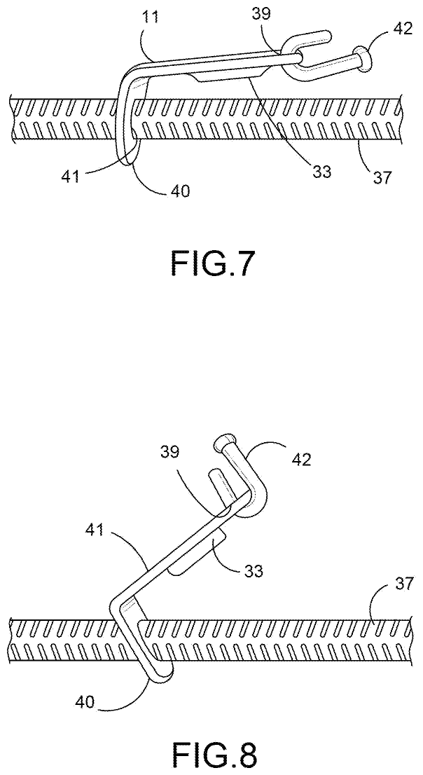

FIGS. 7 and 8 illustrate the use of a drowning rod 37 (for which rebar can be conveniently used) in conjunction with cable clamp 11 being used as a slide lock rather than a clamp, both from a top view and from the side of cable clamp body 11. A trap is attached to the clamp body 11 by means of a “J” hook 42. The tab 40 has been slid over the end of drowning rod 37 through tab opening 41. As shown in FIG. 7, a trapped animal could swim downwardly and cable clamp body/slide lock 11 would slide down the drowning rod 37. However, in FIG. 8, the animal is trying to swing away, and the cable clamp/slide lock body will be canted into its locking position shown in FIG. 8 by the animal's tension being applied to the trap attached to “J” hook 42.

If a drowning cable is used instead of a drowning rod, the drowning cable has to be first anchored in the water as described above, then its free end passed through tab opening 41, and finally anchoring the drowning cable with a second anchor such as an anchoring stake.

The body style C clamp with body 12 is a type of cable/wire clamp that can be used by clamping the drowning cable 38 and a ground stake 37 together simultaneously. (FIGS. 9-13). Body style 12 comprises a top flat plate 11 having legs 44a depending downwardly from the opposite sides of top flat plate 44. (FIGS. 9-11) Legs 44a each have an opening 46 which is large enough to accommodate a ground stake and optionally a drowning cable or wire extending through both openings 46 through legs 44a. The openings have a lazy “V” shape at their bottoms to better cradle a ground stake or cable extending through openings 46.

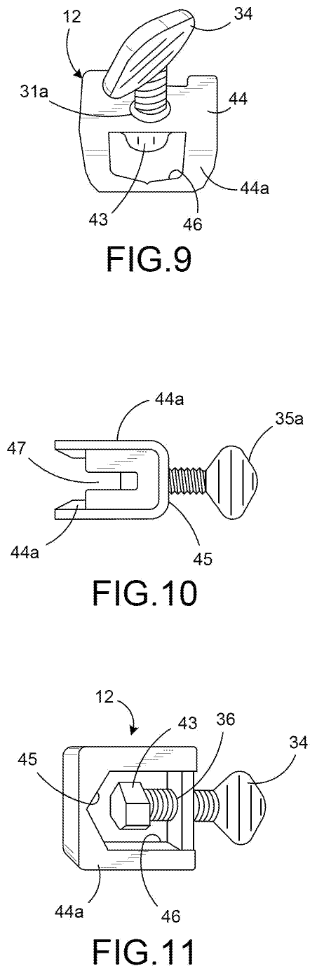

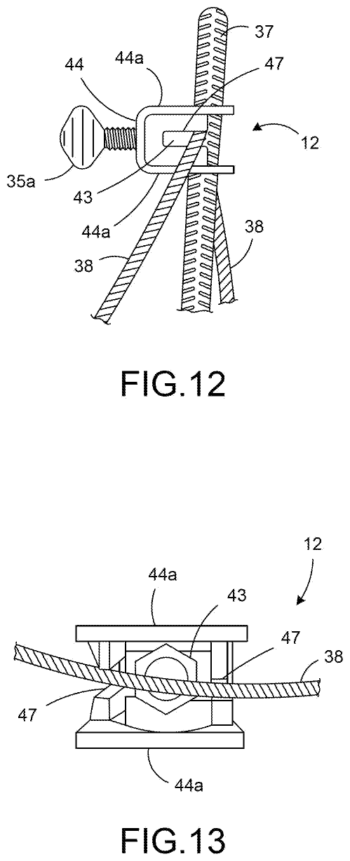

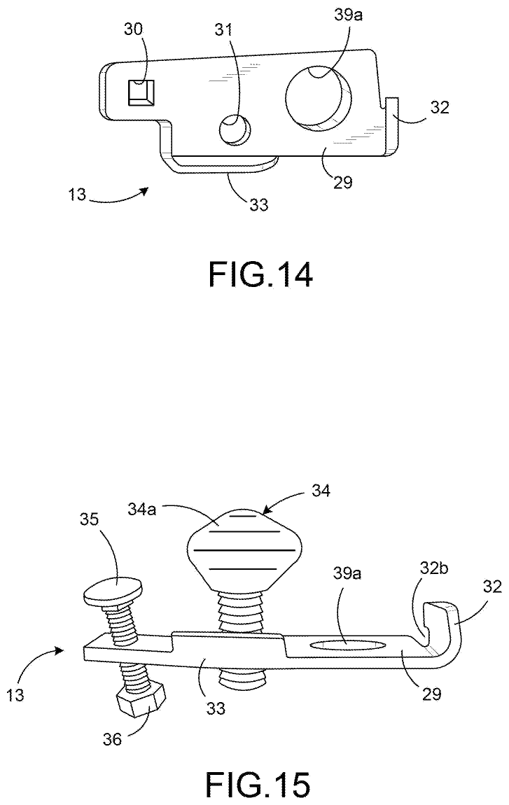

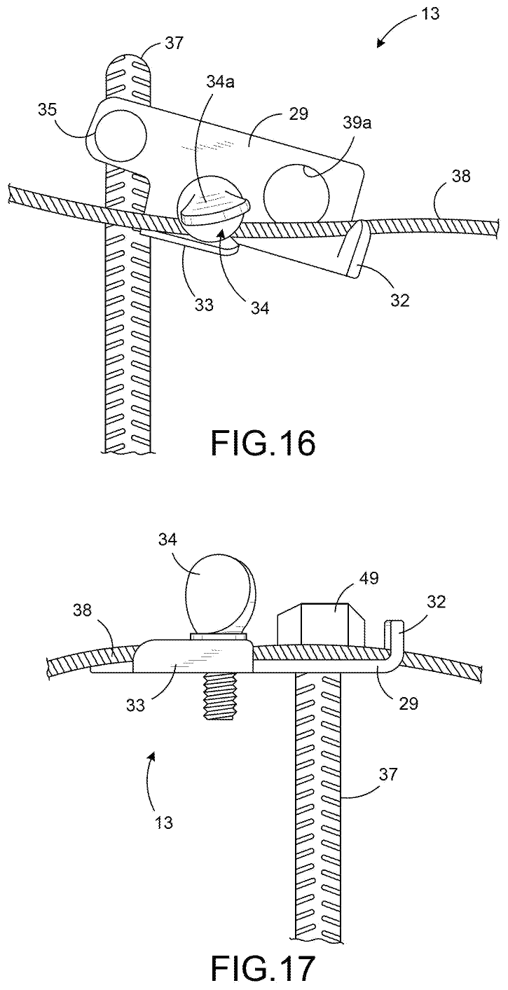

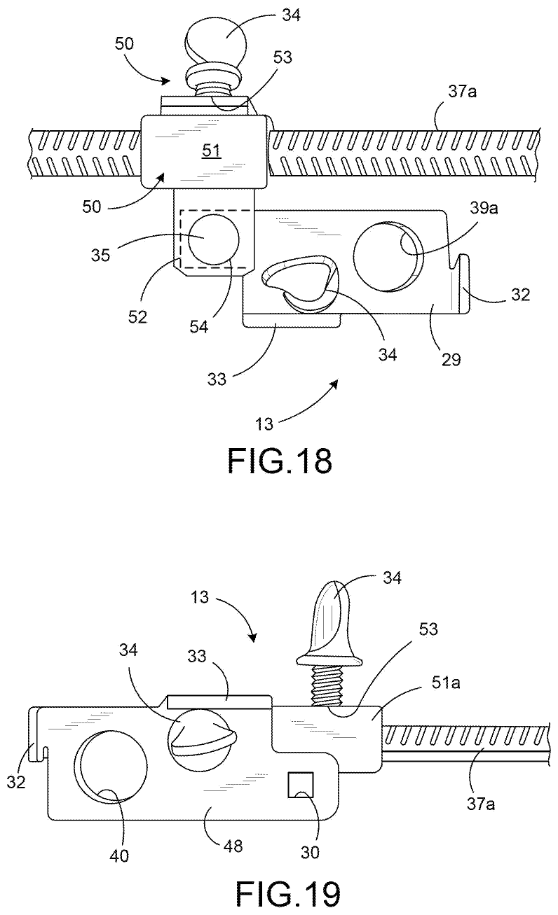

However, it is preferable that body 12 have two short walls 47a extending perpendicularly to side legs 44a a portion of the way from the top plate 44 to the bottom of legs 44a (FIG. 10). These short walls each have a centered slot 47 in them which is wide enough and long enough to embrace the thickness of a drowning cable or wire 38 being used. Yet because walls 47a do not extend all the way to the bottom of downwardly extending legs 44a, there is room below walls 47a and between the openings 46 in legs 44a to pass a ground stake between openings 46 and under a drowning cable located in slot 47 (FIG. 13).

A thumb bolt 34 is threaded through a threaded opening 31a in the top portion 44 of body 12. By threading thumb bolt 34 downwardly into clamping engagement with a ground stake and cable or wire extending through slot 47 and openings 46 respectively, one can securely hold both together, and thus fix cable clamp C in place on the ground stake and hold the desired tension on a drowning cable or wire. A nut or other enlargement is welded or formed on the end of thumb bolt 34 to provide a larger clamping surface for clamping the ground stake and drowning cable or wire together when both are extends through openings 46.

The body 13 of style D is very similar to body 10 of style A, just a little larger and one more circular aperture, so that it can be used in a couple of different ways. Body style D 13 has a flat plate 29, the 90-degree bent tab 33, and the 90-degree bent tab 32 on the right end (as viewed in FIG. 14 or 15), that can have an undercut 32a or a channel 32b. The flat plate also has a connecting square aperture 30, through which a threaded bolt 35 passes. It threads into a threaded nut 36 such that bolt 35 and nut 36 can be tightened around ground stake 37, or through a hole drilled through ground stake 37, to connect the body 10 of style D clamp 13 to a ground stake 37. A threaded circular aperture 31 in plate 29 receives a tension holding/securing threaded thumb screw 34. Finally, flat plate 29 of style D cable clamp 13 includes a circular aperture 39a which is larger than aperture 39 in body style B cable clamp 11, such that a ground stake 37 will fit in aperture 39a. (FIG. 17).

FIGS. 16-19 illustrate the different ways that body style D cable clamp 13 can be used. In FIGS. 16 and 17, tension on drowning cable 38 is maintained by:
1. passing cable 38 around tab 32, through undercut 32a or channel shaped undercut 32b, and through the channel between tab 33 and thumb bolt 34 and under the “thumb” top portion 34a of bolt 34, which projects radially outwardly from the shank of bolt 34; and
2. pulling on the stream anchored drowning cable 38 until the desired tension is achieved, and then tightening down through bolt 34 on top of cable 38 to fix it in place.

However the methods of connecting cable clamp 13 to ground stake 37 as shown in FIGS. 16 and 17 are different. FIG. 16 shows Style D cable clamp 13 connected to a around stake 37 by inserting the connecting bolt 35 through a circular aperture drilled through the ground stake 37 and threading it into nut 36. FIG. 17 shows the ground stake 37 inserted through aperture 39a and, thus connecting cable clamp 13 to ground stake 37. Preferably, ground stake 37 has a top cap 49 which is too large to fit through aperture 39a, thus insuring that cable clamp 13 will not slip over and off the top of ground stake 37.

In FIG. 18, style D cable clamp 13 is combined with a slide through “drowning rod connector” 50 and used with a drowning rod 37a. The drowning rod connector 50 is made from a cut section of ½ inch pipe which forms a sleeve 51. A connector tab 52 extends from the side of sleeve 51, and includes an aperture (not shown) for receiving connector bolt 35, which can pass through said aperture and connect to a nut (not shown), or the hidden aperture can be threaded for receiving connector bolt 35. Connector bolt 35 also passed through aperture 30 in the left end extending portion of flat plate 29 (shown by hidden lines under a portion of tab 52). In this manner, cable clamp 13 is connected to drowning rod 37a. However, a drowning slide lock is placed on drowning rod 37a before cable clamp 13 is connected to drowning cable 37a.

When used with drowning rod 37a, cable clamp 13 is used with drowning rod 37a, a drowning slide lock on drowning rod 37a, and a drowning rod connector 50 on drowning rod 37a, tab 33, tab 32 and thumb bolt 34 on cable clamp body 13 are not used. Once the trapper has one end of the drowning rod 37a inserted into the deep-water bottom, a drowning slide lock and the combined drowning rod connector 50 and connected Type D cable clamp 13 can be slid onto the drowning rod 37a. Once they are positioned where they need to be, the thumb bolt 34 bolt can be tightened. Once the thumb bolt is tightened, a ground stake 37 with a top 49, as shown in FIG. 17, can be inserted through the ground stake aperture 39a and staked into the ground to fix the location of the assembly.

FIG. 19 shows one more option for using style D cable clamp 13, is also a way to use the drowning cable clamp body 11 connected to drowning rod connector 50. There is a circular threaded aperture through the side of sleeve 51, that the tension holding/securing bolt 34 goes through to connect drowning rod connector 50 and clamp body 11 together. The trapper can connect them together by sliding the connector 50 until it is appropriately positioned, then threading the tension holding/securing bolt 34 through the threaded aperture in sleeve 51 until it is tightened against the side of drowning rod 37a, the trapper can then insert a ground stake 37 with a top 49, shown in FIG. 17 style D through the ground stake aperture 39a.

It will finally be understood that the disclosed embodiments represent presently preferred examples of how to make and use the invention but are intended to enable rather than limit the invention. Variations and modifications of the illustrated examples in the foregoing written specification and drawings may be possible without departing from the scope of the invention.

1. A method for securing a drowning cable for the dispatch of a fur bearing animal comprising: using a first anchor to anchor a drowning cable in water deep enough to drown the animal; connecting an animal trap having a connector with an attached slide lock to said drowning cable by slipping said slide lock over the free end of said drowning cable; positioning said animal trap in the desired position for trapping an animal; identifying a position on which to anchor said drowning cable with a second anchor; drawing said drowning cable through said slide lock at said identified anchoring position until a desired tension is achieved on said drowning cable; and clamping said drowning cable to said second anchor located at said anchoring position to maintain said desired degree of tension on said anchoring cable; said clamping step comprising providing and using a cable clamp which comprises: a connector for said second anchor; a plate having a first aperture receiving a clamping bolt and a locating tab projecting from said plate to serve a locator guide to help a trapper position said drowning cable in tension under a clamping portion of said clamping bolt; said method including the step of positioning said clamp against said drowning cable under tension with said cable clamp against said clamp positioning tab and under said clamping portion of said clamping bolt, and tightening said clamping portion of said clamping bolt against said drowning cable.

2. The method of claim 1 in which a stake in the ground is used as said second anchor and said cable clamp is connected to said stake before said stake is embedded in the ground, said stake being embedded in the ground after said cable clamp is clamped to said drowning cable.

3. The method of claim 1 in which said stake is embedded in the ground, said clamp is clamped to said drowning cable, and then connected to said stake.

4. The method of claim 1 in which a ground stake is used as said second anchor and said cable clamp used also comprises: said plate having a second aperture through which a threaded bolt; passes, and a threaded nut into which said threaded bolt threads, whereby said method comprises tightening said threaded bolt around said stake between said threaded bolt and said nut to connect said cable clamp to said stake.

5. The method of claim 4 in which said cable clamp provided also has a channel tab which extends upwardly from said plate at a distance from one side of said clamping bolt sufficient to form a channel through which said drowning cable can pass after passing by and contacting, said locating tab.

6. The method of claim 5 in which said locating tab on said cable clamp provided forms an undercut between said locating tab and said plate at the juncture of said locating tab and said plate, whereby said method includes passing said drowning cable through said undercut to help also locate it in said channel and under said clamping portion of said clamping bolt.

7. The method of claim 1, in which a stake is used as said second anchor and is provided with a lateral through hole through which a bolt can be passed; said cable clamp used also comprises: said plate having a second aperture through which a threaded bolt passes, and a threaded nut into which said threaded bolt threads, whereby said method comprises passing said threaded bolt through said through hole in said stake and tightening said threaded bolt into said nut on the other side of said through-hole in said stake, to connect said cable clamp to said stake.

8. The method of claim 1 in which a ground stake is used as said second anchor and said cable clamp used also comprises: said plate having a second aperture which is a ground stake aperture, in that it is dimensioned such that said ground stake passes through snugly through said second aperture, whereby said cable clamp is connected to said ground stake by passing said ground stake through said second aperture.

9. A method for trapping a fur bearing animal using a cable clamp which can also be used as a slide lock on a drowning rod or drowning cable, said method comprising: providing a cable clamp which comprises: a connector for connecting the cable clamp to a ground anchor; a plate having a first aperture for receiving a clamping bolt and a locating tab projecting from said plate to serve a locator guide to help a trapper position a drowning cable in tension under a clamping portion of a clamping bolt; a second aperture which is a trap connector aperture, located near one end of said cable clamp, such that an animal trap can be connected to said cable clamp by a cable or chain extending to a connector to be hooked into said second aperture; said cable clamp also including a slide lock tab projecting upwardly from said plate at its opposite end from said second aperture, said shed lock tab having a third aperture through which a drowning cable or drowning rod can freely pass; said method of trapping being performable either by:
i. using a first anchor to anchor a drowning cable in water deep enough to drown the animal; connecting an animal trap having a connector with an attached slide lock to said drowning cable by slipping said slide lock over the free end of said drowning cable; positioning said animal trap in the desired position for trapping an animal; drawing said drowning cable through said slide lock until a desired tension is achieved on said drowning cable; anchoring said drowning cable with a second anchor located to maintain said drowning cable in said desired tension and clamping said drowning cable to said second anchor located to maintain said desired degree of tension on said drowning cable; positioning said cable clamp against said drowning cable under tension with said cable clamp against said clamp positioning tab and under said clamping portion of said clamping bolt, and tightening said clamping portion of said clamping bolt against said drowning cable; or by
ii. positioning said cable clamp on a drowning rod or a drowning cable under tension between a water anchor and a ground anchor with said drowning rod or drowning cable passing through said third aperture which is in said slide lock tab and attaching an animal trap to said second aperture which is located in said cable clamp plate and placing said animal trap in the location which the trapper wants to trap the animal.

10. A cable clamp configured for use in trapping animals comprising: a connector for connecting said cable clamp to a drowning cable anchor; a plate having a first aperture for receiving a clamping bolt; a clamping bolt passing through said first aperture, said clamping bolt having a clamping portion; and a locating tab projecting from said plate to serve a locator guide to help a trapper position a drowning cable in tension under said clamping portion of said clamping bolt; said clamping bolt being moveable between a non-clamping position and a clamping position where it would clamp a drowning cable in a clamped position.

11. The cable clamp of claim 10 comprising: said connector for connecting said cable clamp to a drowning cable anchor comprises said plate having a second aperture through which a threaded bolt passes, and a threaded nut into which said threaded bolt threads, whereby said threaded bolt can be tightened around or through a hole in an anchored stake, between said threaded bolt and said nut to connect said cable clamp to an anchoring stake.

12. The cable clamp of claim 11 in which said cable clamp also has a channel tab which extends upwardly from said plate at a distance from one side of said clamping bolt sufficient to form a channel through which a drowning cable can pass after passing by and contacting said locating tab.

13. The cable clamp of claim 12 in which said locating tab on said cable clamp forms an undercut between said locating tab and said plate at the juncture of said locating tab and said plate, whereby a drowning cable can be passed by said undercut, to help also locate it, in said channel and under said clamping portion of said clamping bolt.

14. The cable clamp of claim 10 in which said connector for connecting a drowning cable to a drowning cable anchor comprises said plate having a second aperture which is dimensioned such that a ground stake can be passed snugly through said second aperture, whereby said cable clamp can be connected to said ground stake anchor by passing said ground stake through said second aperture.

15. The cable clamp of claim 10 which can alternatively be used as a slide lock on a drowning cable or drowning rod comprising: said plate including a second aperture which is a trap connector aperture, located near one end of said cable clamp, such that an animal trap can be connected to said cable clamp by a cable or chain extending to a connector to be hooked into said second aperture; said cable clamp also including a slide lock tab projecting upwardly from said plate at its opposite end from said second aperture, said slide lock tab having a third aperture through which a drowning cable or drowning rod can freely pass until an animal is trapped and said plate is canted at an angle to a drowning rod or drowning cable.

16. A cable clamp configured for use in trapping animals comprising:
a top plate having legs depending downwardly from opposite sides of said top plate; each of said legs having an opening which is large enough to accommodate a ground stake and optionally a drowning cable or wire extending through both said openings, said openings have a lazy “V” shape at their bottoms to better cradle a ground stake or cable extending through openings;
two short walls extending perpendicularly to said side legs a portion of the way from said top plate to the bottom of said legs leaving room below said walls and between said openings in said legs to pass a ground stake between said openings and under a drowning cable located; each of said short walls having a centered slot in them which is wide enough and long enough to embrace the thickness of a drowning cable; a clamping bolt threaded through a threaded opening in said top plate which can be threaded downwardly into clamping engagement with a ground stake and drowning extending through said slot and said openings respectively.
